(19) United States
(12) Patent Application Publication
(10) Pub. No.: US 2011/0148802 A1
(43) Pub. Date: Jun. 23, 2011

(54) PRESENTATION APPARATUS EQUIPPED WITH A TOUCH PANEL

(76) Inventor: Eric OH-YANG, Miao-Lih Hsien (TW)

(21) Appl. No.: 12/645,233

(22) Filed: Dec. 22, 2009

(51) Int. Cl. G06F 3/045

(52) U.S. Cl. 345/174

(57) ABSTRACT

A presentation apparatus equipped with a touch panel comprises a touch panel, a circuit board and a housing. The touch panel aims to detect user's finger touch and movement and convert them to a detection signal. The circuit board is electrically connected to the touch panel and includes a touch unit linking to the touch panel to convert the detection signal to an electronic signal, a wireless connection unit connecting wirelessly to a presentation display device to transmit signals and a central processing unit. The housing includes an accommodation portion to hold the circuit board and the touch panel and a window corresponding to the touch panel. The central processing unit is electrically connected to the touch unit and the wireless connection unit.

### FIELD OF THE INVENTION

The present invention relates to a presentation controller and particularly to a presentation apparatus equipped with a touch panel capable of connecting wirelessly to a presentation display device.

### BACKGROUND OF THE INVENTION

Doing business in many occasions nowadays has to rely on presentation to explain intended topics or incorporate it in speeches to convey intended contents to the audience to make them more impressive. The commonly adopted presentation at present is done through a presentation display medium (such as a notebook computer) coupling with a projector. Presenter delivers a set of prepared presentation content through output from the notebook computer projected through the projector to a display screen. The presenter controls the notebook computer to switch the content on the display screen. Such a direct control approach restricts the movement range of the presenter during making speech or presentation by the mounting location of the notebook computer.

Moreover, many presentations these days contain animation images or are directly linked to browsing software to make deep impressions to the audience. The conventional presentation apparatus merely has page up or down switch function. To perform more complicated operation such as moving cursor, menu selection or marking underlines on the presentation content is impossible through the presentation apparatus. The presenter has to go to the notebook computer to do necessary alterations and operation. It creates a lot of problems to the presenter and wastes time of making speech.

### SUMMARY OF THE INVENTION

The primary object of the present invention is to solve the problems of the conventional presentation apparatus that cannot perform complicated operation such as moving cursor, menu selection or marking underlines on the presentation content by providing an improved presentation apparatus to facilitate efficient and smooth delivery of presentation.

To achieve the foregoing object, the present invention provides a presentation apparatus equipped with a touch panel to enable a user to link and control a presentation display device. The present invention comprises a touch panel, a circuit board and a housing. The touch panel aims to detect user's finger touch and movement, and convert them to a detection signal. The circuit board is electrically connected to the touch panel and includes a touch unit linking to the touch panel to convert the detection signal to an electronic signal, a wireless connection unit to connect wirelessly to the presentation display device to mutually transmit signals and a central processing unit electrically connected to the touch unit and the wireless connection unit. The housing includes an accommodation portion to hold the circuit board and the touch panel and a window corresponding to the touch panel.

By means of such a construction, the presentation apparatus equipped with a touch panel of the present invention can be linked to a notebook computer in a wireless fashion. A presenter can directly perform operation such as moving cursor, menu selection or marking underlines on the presentation content on the podium through the presentation apparatus. The presenter also can select other desired software in addition to the presentation content through cursor movement or mouse click to evoke animation images and operation to augment the impression of the audience. Through the wireless link, the presenter also can move freely within a selected range without being constrained by the location and distance of the notebook computer.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of present the invention.

FIG. 2 is an exploded view of an embodiment of the present invention.

FIG. 3 is a diagram showing a circuit unit of an embodiment of the present invention.

FIG. 4A is a circuit diagram of an embodiment of the present invention for the touch unit, control unit and test unit.

FIG. 4B is a circuit diagram of an embodiment of the present invention for the wireless connection unit.

FIG. 4C is a circuit diagram of an embodiment of the present invention for the central processing unit.

FIG. 4D is a circuit diagram of an embodiment of the present invention for the battery set and voltage boosting unit.

FIG. 4E is a circuit diagram of an embodiment of the present invention for the voltage detection unit.

### DETAILED DESCRIPTION OF THE PREFERRED EMBODIMENTS

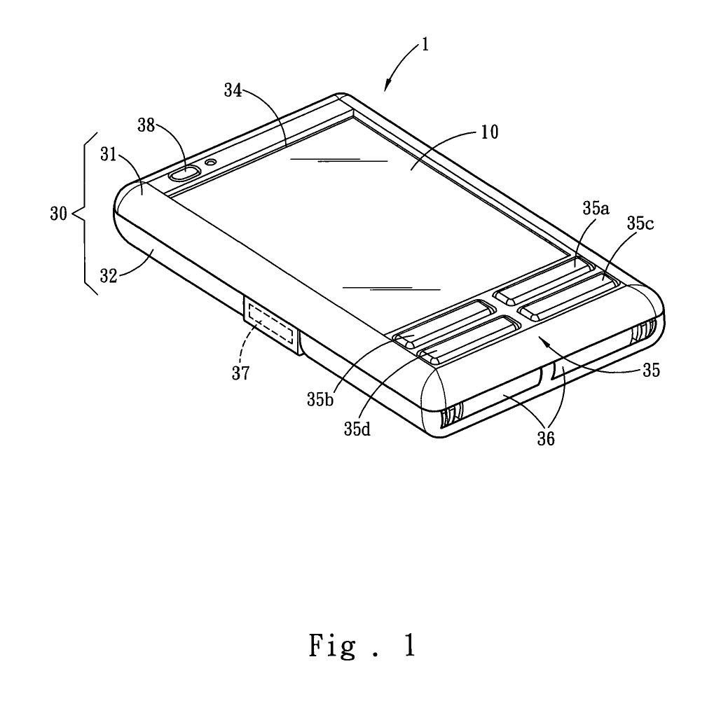

Please refer to FIGS. 1, 2 and 3 for an embodiment of the present invention. The present invention aims to provide a presentation apparatus equipped with a touch panel to allow a user to link and control a presentation display device (such as a notebook computer). The apparatus comprises a touch panel 10, a circuit board 20 and a housing 30. The touch panel 10 aims to detect user's finger touch and movement, and convert them to a detection signal. The circuit board 20 is electrically connected to the touch panel 10 and includes a touch unit 21, a wireless connection unit 22, a central processing unit 23, a battery set 24, a voltage boosting unit 25, a voltage detection unit 26, a test unit 27 and a plurality of control units 28. In this embodiment, the housing 30 includes an upper housing 31, a lower housing 32, an accommodation portion 33 located in the lower housing 32 and a window 34 corresponding to the touch panel 10. The accommodation portion 33 aims to hold the circuit board 20 and the touch panel 10.

In this embodiment, the user touches the touch panel 10 with fingers and moves the fingers to input a command so that the touch panel 10 generates a detection signal. The touch panel 10 is connected to the touch unit 21 on the circuit board 20, and sends the detection signal to the touch unit 21. The touch unit 21 is electrically connected to the central processing unit 23 and converts the detection signal to an electronic signal sent to the central processing unit 23. The central processing unit 23 interprets or processes the electronic signal and sends to the wireless connection unit 22. The wireless connection unit 22 sends the processed electronic signal to the presentation display device. The wireless connection unit 22 is a wireless network communication means selected from Bluetooth, infrared and a wireless network to connect to the presentation display device and transmit signals. The presentation display device receives the electronic signal from the wireless connection unit 22 and performs operation corresponding to the command input by the user.

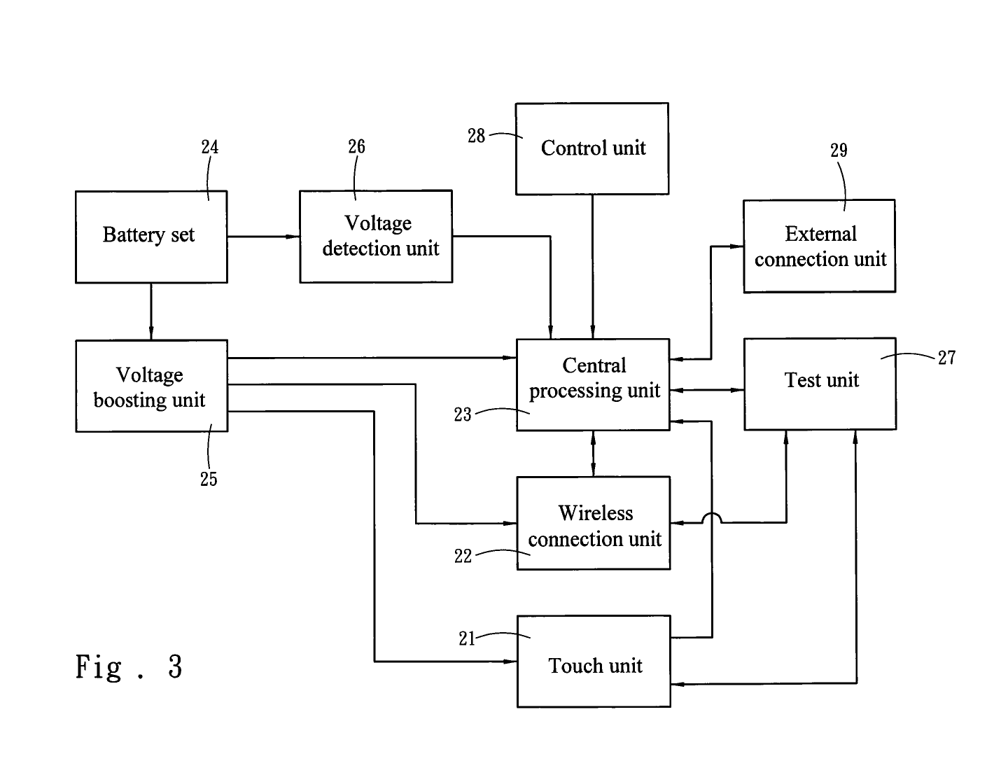

Please referring to FIG. 3, in the circuit board 20 according to the present invention, the battery set 24 aims to supply electric power to the circuit board 20 and the voltage boosting unit 25 aims to boost the voltage of the electric power. The boosted voltage is sent to other circuit units required input voltage such as the central processing unit 23, wireless connection unit 22 and touch unit 21 and the like. The voltage detection unit 26 also is electrically connected to the battery set 24 to detect the voltage of the battery set 24. In the event that the voltage of the battery set 24 is too low, that means the battery is approaching an exhausted condition, and the voltage detection unit 26 sends an electronic signal with low voltage detection to the central processing unit 23 which informs the user that the power of the battery set 24 is in a deficient state. Moreover, the test unit 27 is electrically connected to the central processing unit 23, wireless connection unit 22 and touch unit 21. The test unit 27 provides a simple error test. In the event that a problem occurred to the presentation apparatus, the test unit 27 tests and identifies first which circuit unit owns the problem, then a following process can be executed.

In addition, in this embodiment, the circuit board 20 also contains the control unit 28 to provide other functions desired such as left button and right button of a mouse, page up and down switching of presentation content, and power supply switch. Hence through the control unit 28, the user can input commands of the mouse left and right buttons, and page up and down switching of presentation content. Through the central processing unit 23 and the wireless connection unit 22, the commands are transmitted to the presentation display device to control alterations of the presentation content. Furthermore, the circuit board 20 also contains an external connection unit 29 to expand the presentation apparatus 1 equipped with the touch panel 10. In this embodiment, the external connection unit 29 is an USB port which can be connected to the presentation display device through an USB cable to charge the presentation apparatus 1 or access data stored in the presentation apparatus 1 through the presentation display device. The external connection unit 29 may also be a memory card connection port or an external expansion device.

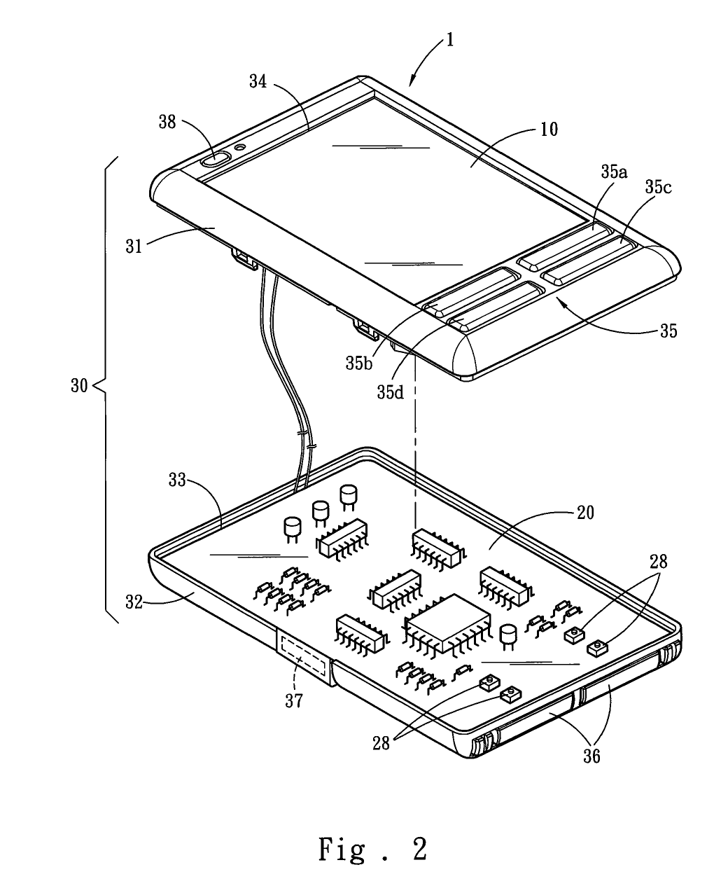

Also referring to FIGS. 2 and 3, the housing 30, in addition to the accommodation portion 33 to hold the circuit board 20 and touch panel 10 and the window 34 corresponding to the touch panel 10, the upper housing 31 also includes a button set 35 corresponding to the control unit 28 and a power supply switch button 38, and a slot 37 corresponding to the external connection unit 29. The button set 35 includes a plurality of pushbuttons 35a, 35b, 35c and 35d that are depressible by the user to trigger the control unit 28. The lower housing 32 has a power supply slot 36 corresponding to the battery set 24. In this embodiment, the battery set 24 is electrically connected to a rechargeable battery (not shown in the drawings), and the battery can be changed and replaced through the power supply slot 36.

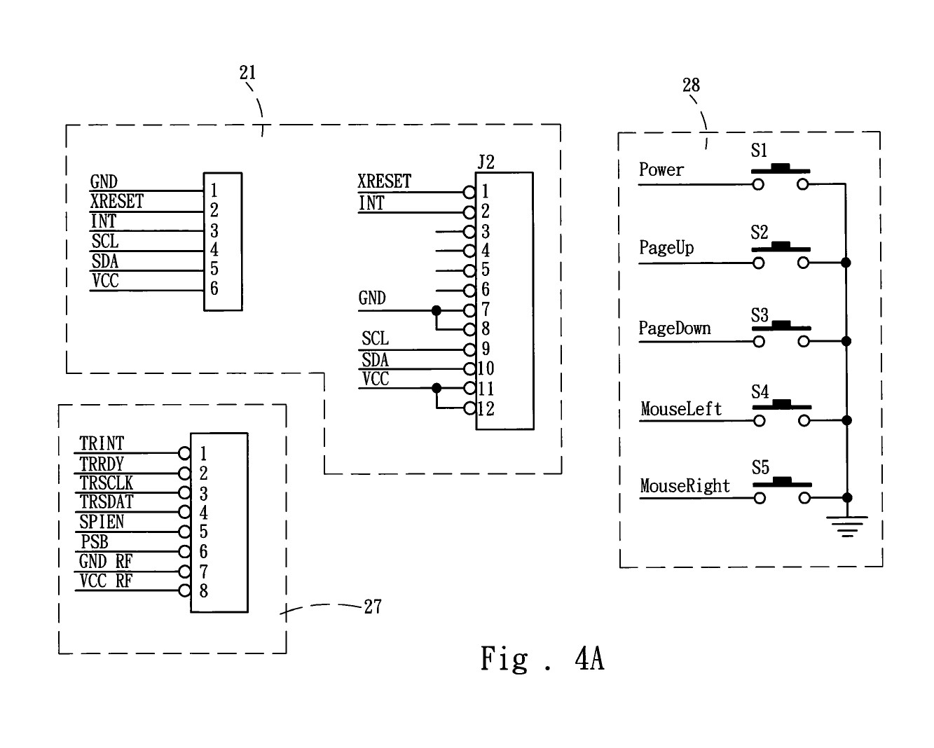

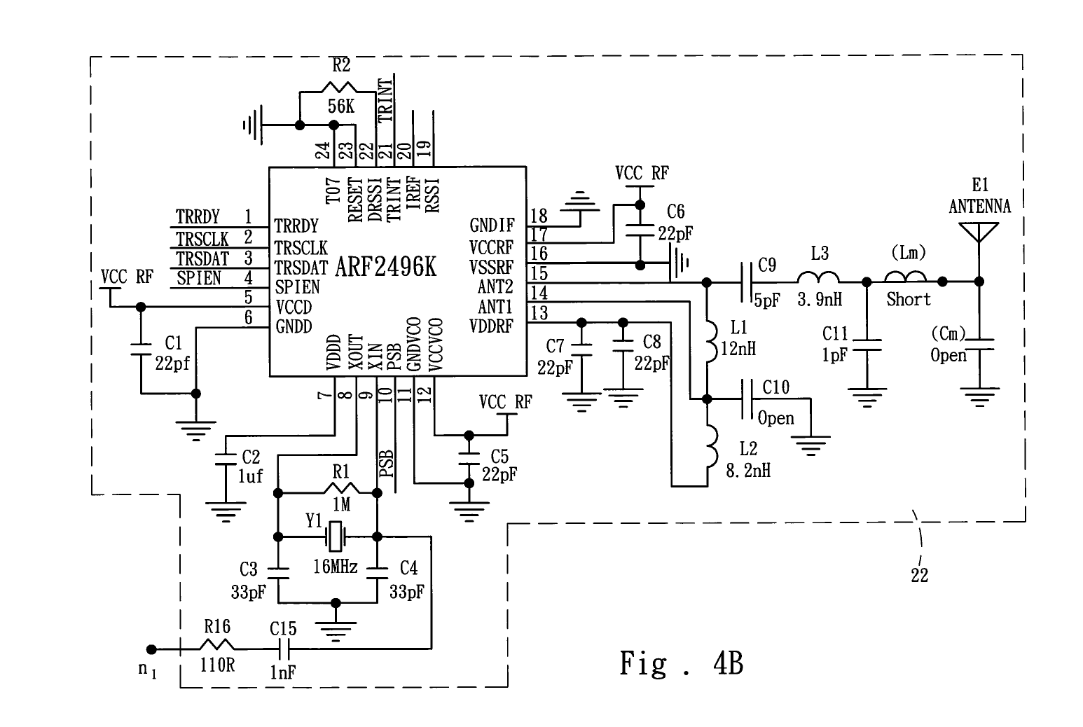

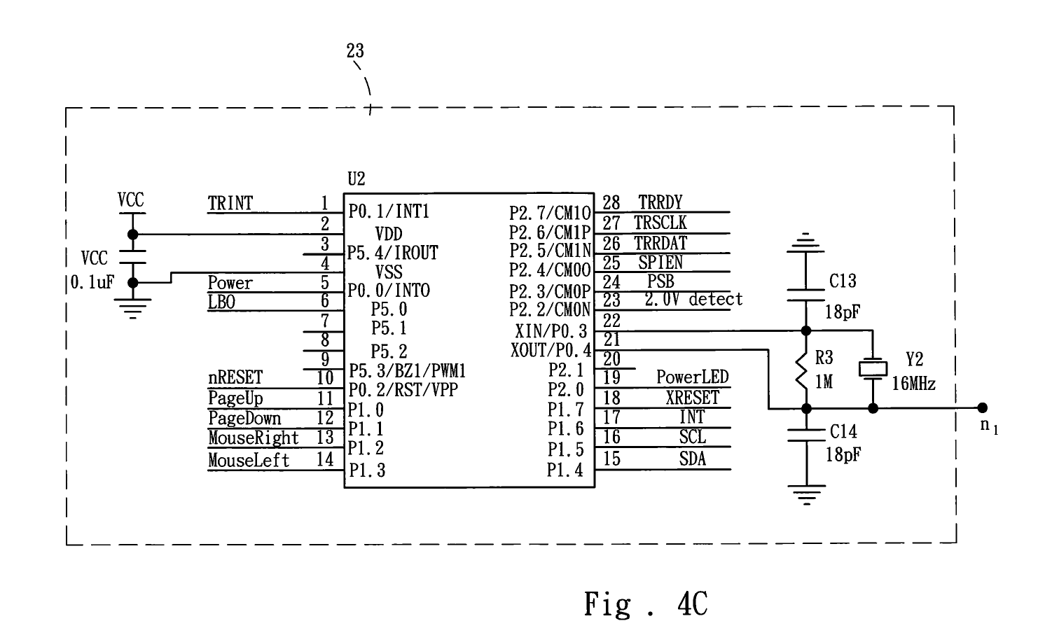

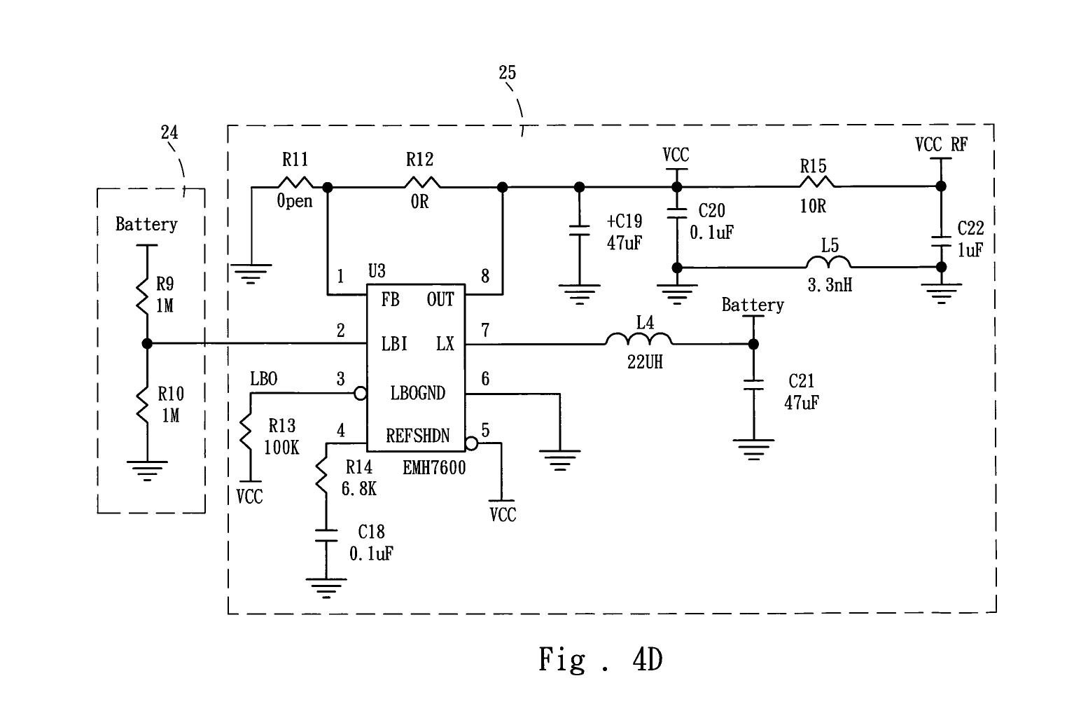

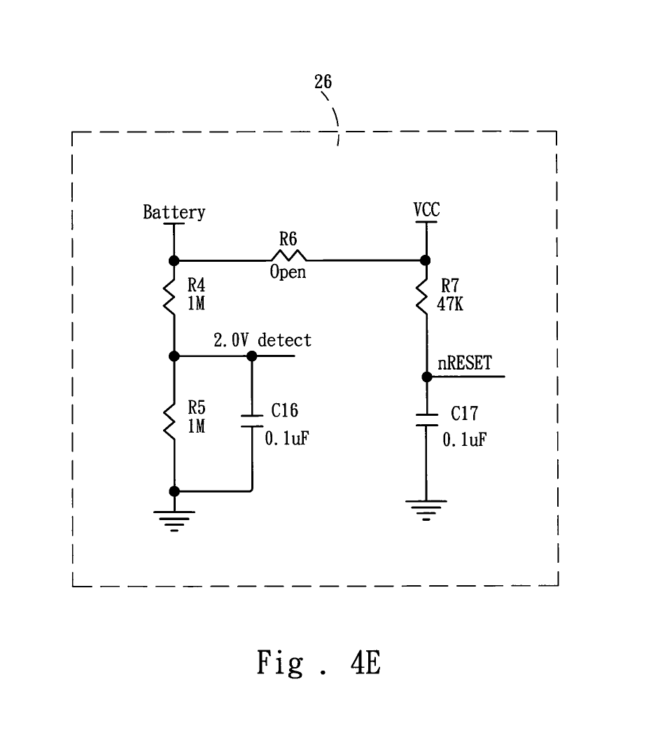

Refer to FIGS. 4A through 4E for circuit diagrams of the embodiment. They are mating the circuit units shown in FIG. 3. To facilitate drawing, the connection nodes of the circuit units are marked by English names. The connection nodes of two different circuit units are marked by the same English name to indicate that they are connected to two different circuit units.

As a conclusion, the presentation apparatus equipped with a touch panel provided by the present invention is connected to a presentation display device. It enables a presenter to stand on a podium and directly delivery presentation content through the presentation apparatus equipped with the touch panel such as moving cursor, menu selection or marking underlines. The presenter also can activate software other than the presentation content by moving the cursor or clicking the mouse to evoke animation images and actual operation to increase audience's impression. Moreover, through the wireless connection, the presenter can move freely within a selected range without being constrained by the mounting location and distance of the notebook computer.

What is claimed is:

1. A presentation apparatus equipped with a touch panel to allow a user to link and control a presentation display device, comprising:
a touch panel which detects touch and movement of user's fingers and converts to a detection signal;
a circuit board which is electrically connected to the touch panel and includes a touch unit connecting to the touch panel to convert the detection signal to an electronic signal, a wireless connection unit connecting to the presentation display device via wireless connection to transmit signals and a central processing unit which is electrically connected to the touch unit and the wireless connection unit; and
a housing which contains an accommodation portion to hold the circuit board and the touch panel and a window corresponding to the touch panel.

2. The presentation apparatus of claim 1, wherein the wireless connection unit is a wireless network communication means selected from the group consisting of Bluetooth, infrared and a wireless network to connect to the presentation display device to perform transmission therebetween.

3. The presentation apparatus of claim 1, wherein the circuit board further includes a battery set to provide electric power for the circuit board.

4. The presentation apparatus of claim 3, wherein the circuit board further includes a voltage boosting unit which is electrically connected to the battery set to boost the voltage of electric power supplied by the battery set.

5. The presentation apparatus of claim 3, wherein the circuit board further includes a voltage detection unit which is electrically connected to the battery set to detect the electric power of the battery set.

6. The presentation apparatus of claim 1, wherein the circuit board further includes a test unit to provide simple error test.

7. The presentation apparatus of claim 1, wherein the circuit board further includes a plurality of control units connecting to the central processing unit and the housing includes a plurality of pushbuttons corresponding to the control units.

8. The presentation apparatus of claim 1, wherein the circuit board further includes an external connection unit and the housing includes a slot corresponding to the external connection unit.

9. The presentation apparatus of claim 8, wherein the slot is selectively an USB port, a memory card connection port or an external expansion device.
